(19) United States
(12) Patent Application Publication
(10) Pub. No.: US 2019/0044144 A1
(43) Pub. Date: Feb. 7, 2019

(54) ACTIVATED THREE DIMENTIONAL CARBON NETWORK STRUCTURE, METHOD FOR FABRICATING THE SAME AND ELECTRODE COMPRISING THE SAME

(71) Applicant: SOGANG UNIVERSITY RESEARCH FOUNDATION, Seoul (KR)

(72) Inventors: Jun Hyuk MOON, Seoul (KR); Cheol Ho KIM, Jeollabuk-do (KR)

(21) Appl. No.: 16/048,443

(22) Filed: Jul. 30, 2018

(30) Foreign Application Priority Data
Aug. 1, 2017 (KR) 10-2017-0097852

(51) Int. Cl. H01M 4/587; H01M 4/96; H01M 10/0525; H01M 4/133; H01G 11/40; H01G 11/24; H01G 11/86

(52) U.S. Cl. CPC H01M 4/587; H01M 4/96; H01M 10/0525; H01M 2004/021; H01G 11/40; H01G 11/24; H01G 11/86; H01M 4/133

(57) ABSTRACT

The present specification provides an activated three-dimensional carbon network structure, a method for fabricating the same, and an electrode including the same.

### TECHNICAL FIELD

The present specification claims priority to and the benefit of Korean Patent Application No. 10-2017-0097852 filed in the Korean Intellectual Property Office on Aug. 1, 2017, the entire contents of which are incorporated herein by reference.

The present invention relates to an activated three-dimensional carbon network structure, a method for fabricating the same, and an electrode including the same.

### BACKGROUND ART

Recently, a demand for a high performance portable power supply has been increasing. These portable power supplies are the essential parts of a finished product that is indispensably used for all the mobile information communication devices, electronic devices, and the like. Lithium secondary batteries and supercapacitors are representative of the energy storage systems that have been most widely developed so far. In particular, secondary batteries exhibit excellent characteristics in terms of energy density which can be accumulated per unit weight, but low service life characteristics and output characteristics remain as problems, so that an improvement is needed. In comparison, the time required for charging and discharging a supercapacitor is much shorter than that of a secondary battery, and the supercapacitor has excellent output density and service life characteristics. However, since supercapacitors exhibit characteristics lower than secondary batteries in terms of energy density, research and development have been conducted to improve the energy density.

The supercapacitor exhibits an energy storage system at a level between a dielectric capacitor and a battery and exhibits high service life characteristics and stability, and has been rapidly emerging as a future energy storage means due to various advantages such as rapid charging. The supercapacitor is composed of two types of an electric double layer capacitor and a pseudo capacitor, and it is necessary to simultaneously exhibit the two capacitors in order to exhibit high capacitance characteristics. The electric double layer capacitor uses a carbon material having excellent stability as an electrode material. In particular, when a specific surface area, which a surface of an electrode has, is wider, an electric double layer in a large region can be formed, and as a result, an energy storage capacitance is improved, and accordingly, a carbon material having various pore structures is used. Further, a pseudo capacitor is greatly affected by a reaction between a functional group which a material has and an electrolyte due to the capacitance caused by a chemical reaction occurring on the surface of the electrode material.

In particular, ultra-small precision mechanical component elements or ultrafine electric and electronic elements have been recently developed, but development of a micro-size energy supply device is required to supply energy to such a precision ultrafine element. However, the development of a micro-size energy supply device still remains at an early stage, and studies to improve energy density and output density are in a progression step. As an electrode material applied to such an energy supply device for a micro element, a thin film-type carbon material is usually used.

As a method for manufacturing a thin film-type carbon material, a chemical vapor deposition (CVD) method or a method using electrodeposition or an etching process (lithography) was usually used. In order to suitably apply an electrode material to a micro element, attempts have been made to widen a specific surface area by designing a pore structure in a thin film or using carbon nanotube structures which are vertically aligned.

Meanwhile, Korean Patent No. 10-1356791 relates to a thin film-type supercapacitor and a method for fabricating the same, and discloses a method for fabricating an electrode film by using graphene or graphene oxide, a method for forming a two-dimensional electrode by separating a graphene or graphene oxide electrode film into two independent electrodes through a patterning technique, an in-plane structure which the two-dimensional electrode has, a method for forming a current collector on the electrode, and a method for fabricating a supercapacitor having a micrometer scale thickness by supplying an electrolyte to a two-dimensional electrode.

### DETAILED DESCRIPTION OF THE INVENTION

### Technical Problem

The present invention has been made in an effort to provide an activated three-dimensional carbon network structure, a method for fabricating the same, and an electrode including the same.

However, a technical problem to be solved by the present invention is not limited to the aforementioned problem, and other problems that are not mentioned may be clearly understood by a person skilled in the art from the following description.

### Technical Solution

An exemplary embodiment of the present invention provides an activated three-dimensional carbon network structure which is composed of a plurality of nodes and a fiber connecting adjacent nodes, in which a plurality of unit spaces divided by the nodes and the fiber is repeatedly arranged in three-dimensional contact with each other, a distance between a center of one node and a center of a node adjacent to the one node is 100 nm or more and 3 μm or less, a volume of one unit space is 90% or more and 110% or less of a volume of the other unit space, and the nodes and the fiber include nanopores.

Another exemplary embodiment of the present invention provides a method for fabricating an activated three-dimensional carbon network structure, the method including: preparing a photoresist layer; irradiating a three-dimensional light interference pattern onto the photoresist layer by using a plurality of coherent parallel lights; forming a three-dimensional polymer network structure by developing the photoresist layer onto which the three-dimensional light interference pattern is irradiated; forming a three-dimensional carbon network structure by sintering the three-dimensional polymer network structure; and forming an activated three-dimensional carbon network structure by treating the three-dimensional carbon network structure with a strong base, and then sintering the treated three-dimensional carbon network structure,

in which the activated three-dimensional carbon network structure is composed of a plurality of nodes and fibers connecting adjacent nodes, a plurality of unit spaces divided by the nodes and the fiber is repeatedly arranged in three-dimensional contact with each other, and the nodes and the fibers include nanopores.

Still another exemplary embodiment of the present invention provides an electrode including the activated three-dimensional carbon network structure.

### Advantageous Effects

The activated three-dimensional carbon network structure according to an exemplary embodiment of the present invention may implement a very high specific surface area and a high capacitance by having a structure where tiny unit spaces are regularly arranged and including nanopores in a node and a fiber, which constitute a framework.

The activated three-dimensional carbon network structure according to an exemplary embodiment of the present invention may implement both a high volumetric energy density (VED) and a high areal energy density (AED).

The activated three-dimensional carbon network structure according to an exemplary embodiment of the present invention has a regular pore structure, and thus has an advantage in that an ideal capacitor operation can be made even at an ultra-high speed scan rate.

The fabrication method according to an exemplary embodiment of the present invention may fabricate a regular activated three-dimensional carbon network structure by a simple process, unlike methods for fabricating an electrode by using chemical deposition, and the like in the related art.

The activated three-dimensional carbon network structure according to an exemplary embodiment of the present invention is a monolithic structure, and has an advantage in that it is possible to overcome a problem such as a decrease in an ion active surface due to a high interlayer contact resistance and an irregular interlayer interval in a laminated electrode in the related art.

The activated three-dimensional carbon network structure according to an exemplary embodiment of the present invention can be applied as an electrode material for a supercapacitor, and is applied to an ultra-small electronic device field such as a micro electromechanical system (MEMS), thereby implementing a high performance as compared to an existing three-dimensional carbon network structure.

### BRIEF DESCRIPTION OF DRAWINGS

FIG. 1 is a scanning electron microscope image of an activated three-dimensional carbon network structure according to an exemplary embodiment of the present invention.

FIG. 2 is a scanning electron microscope image illustrating one surface of an activated three-dimensional carbon network structure according to an exemplary embodiment of the present invention.

FIG. 3 is a scanning electron microscope image illustrating one surface of an activated three-dimensional carbon network structure according to an exemplary embodiment of the present invention.

FIG. 4 schematically illustrates the structure of the three-dimensional carbon network structure of FIG. 3.

FIG. 5 illustrates a scanning electron microscope image of a three-dimensional carbon network structure fabricated according to Example 1.

FIG. 6 illustrates an electron microscope image of an activated three-dimensional carbon network structure fabricated according to Example 1 (KOH 3 M).

FIG. 7 illustrates an electron microscope image of an activated three-dimensional carbon network structure fabricated according to Example 2 (KOH 5 M).

FIG. 8 illustrates an electron microscope image of an activated three-dimensional carbon network structure fabricated according to Example 3 (KOH 7 M).

FIG. 9 illustrates an electron microscope image of an activated three-dimensional carbon network structure fabricated according to Example 4 (KOH 9 M).

FIG. 10 illustrates a transmission electron microscope image of a fiber region of an activated three-dimensional carbon network structure fabricated according to Example 1 (KOH 3 M).

FIG. 11 illustrates a transmission electron microscope image of a fiber region of a three-dimensional carbon network structure fabricated according to the Comparative Example.

FIG. 12 illustrates effectively active regions of Examples 1 to 4 and the Comparative Example.

FIG. 13 illustrates electrochemical capacitances (cyclic voltammetry curves) of Examples 1 to 4 and the Comparative Example.

FIG. 14 illustrates galvanostatic charge/discharge curves at a current density of 1 mA/cm² of Examples 1 to 4 and the Comparative Example.

FIG. 15 schematically illustrates a process of fabricating a micro supercapacitor according to Experimental Example 3.

FIG. 16 is an image in which a micro supercapacitor electrode having an interdigit structure according to Experimental Example 3 is enlarged by a scanning electron microscope.

FIG. 17 illustrates an image in which the micro supercapacitor according to Experimental Example 3 is not enlarged.

FIG. 18 illustrates cyclic voltammetry curves of the micro supercapacitor electrode having an interdigit structure according to Example 3 at 100 mV/s.

FIG. 19 illustrates cyclic voltammetry curves of the micro supercapacitor electrode having an interdigit structure according to Example 3 at 1,000 mV/s.

FIG. 20 illustrates storage capacitance of the micro supercapacitor electrode having an interdigit structure according to Example 3 over cycle.

### BEST MODE

Hereinafter, exemplary embodiments of the present invention will be described in detail such that a person skilled in the art to which the present invention pertains can easily carry out the present invention with reference to the accompanying drawings. However, the present invention can be implemented in various different forms, and is not limited to the exemplary embodiments described herein.

When one part “includes” one constituent element in the present specification, unless otherwise specifically described, this does not mean that another constituent element is excluded, but means that another constituent element may be further included.

Throughout the specification of the present application, a term of a degree, such as “about” or “substantially”, is used in a corresponding numerical value or used as a meaning close to the numerical value when a natural manufacturing and a substance allowable error are presented in a described meaning, and is used to prevent an unconscientious infringer from illegally using disclosed contents including a numerical value illustrated as being accurate or absolute in order to help understanding of the present invention.

Throughout the specification of the present application, terms, such as a “step (of performing or doing) ˜” or a “step of ˜” does not mean a “step for ˜”.

Hereinafter, the present specification will be described in more detail.

An exemplary embodiment of the present invention provides an activated three-dimensional carbon network structure which is composed of a plurality of nodes and a fiber connecting adjacent nodes, in which a plurality of unit spaces divided by the nodes and the fiber is repeatedly arranged in three-dimensional contact with each other, a distance between a center of one node and a center of a node adjacent to the one node is 100 nm or more and 3 μm or less, a volume of one unit space is 90% or more and 110% or less of a volume of the other unit space, and the nodes and the fiber include nanopores.

The activated three-dimensional carbon network structure according to an exemplary embodiment of the present invention is an activated monolithic three-dimensional carbon network structure, and has an advantage in that it is possible to minimize or remove an interlayer contact resistance problem which was problematic in a laminated structure in the related art.

The activated three-dimensional carbon network structure according to an exemplary embodiment of the present invention has an advantage in that it is possible to exhibit a stable electrode performance as compared to a porous structure in the related art because uniform unit spaces are constantly arranged.

Furthermore, the activated three-dimensional carbon network structure according to an exemplary embodiment of the present invention has a higher specific surface area by including nanopores in a node and a fiber, which constitute a framework, thereby implementing a high capacitance.

The nanopores may be distributed inside and/or on the surface of the node and the fiber. Specifically, when at least a part of the nanopores are exposed to the surface of the node and the fiber, crater shapes may be formed on the surface of the node and the fiber.

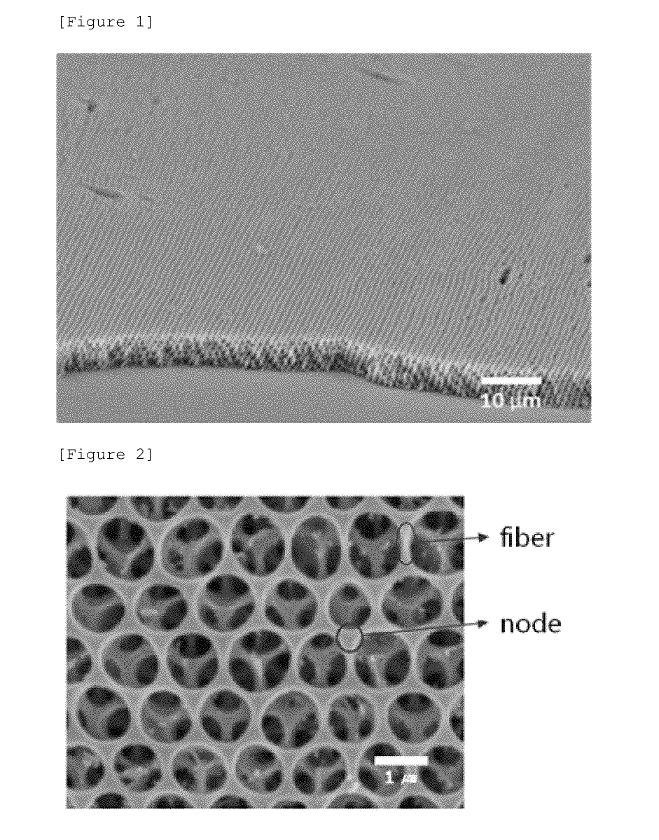

FIG. 1 is a scanning electron microscope image of an activated three-dimensional carbon network structure according to an exemplary embodiment of the present invention. Specifically, FIG. 1 is a scanning electron microscope image of an activated three-dimensional carbon network structure according to the following Example 4. According to FIG. 1, it can be confirmed that the unit spaces of the activated three-dimensional carbon network structure are regularly arranged. For reference, in the case of FIG. 1, it can be confirmed that a focus is made on the cross section of the activated three-dimensional polymer network structure at the forefront, and the distortion of the image occurs as the image goes from the front to the rear. This distortion is only caused by the distortion of the scanning electron microscope, and the volumes of the unit spaces of the activated three-dimensional polymer network structure of the present invention are constantly arranged.

According to an exemplary embodiment of the present invention, the nanopores may have a diameter of 0.5 nm or more and 2 nm or less. Specifically, the nanopores may have a diameter of 0.7 nm or more and 2 nm or less, 0.5 or more and 1.5 nm or less, and 0.7 nm or more and 1.5 nm or less.

When a porous structure is fabricated by a method such as a blowing agent or electrospinning as in the related art, a different performance may be exhibited at each position because pores cannot be regularly formed, and there is a problem in terms of durability. In contrast, the activated three-dimensional carbon network structure according to an exemplary embodiment of the present invention has an advantage in that the aforementioned problem can be removed because the structure is controlled by a structure in which the unit spaces corresponding to the pores are regularly arranged.

Further, even in the case where the three-dimensional carbon network structure is fabricated by a 3D printing method which has been recently actively studied, it is impossible to control a distance between centers of adjacent nodes to 3 μm or less as in the three-dimensional carbon network structure according to an exemplary embodiment of the present invention, a regular structure in a millimeter unit can be merely fabricated due to characteristics of the 3D printing method, but it is impossible to fabricate a regular three-dimensional structure in which the distance between adjacent node centers is controlled to 3 μm or less, as in the present invention.

According to an exemplary embodiment of the present invention, the node may mean a site where two or more of the fiber are crossed with each other.

According to an exemplary embodiment of the present invention, the unit space may mean a pore or channel in the activated three-dimensional carbon network structure. Specifically, the unit space may mean a three-dimensional closed space surrounded by a virtual plane formed when the node and the fiber connect the nodes.

According to an exemplary embodiment of the present invention, the unit space is brought into contact with an adjacent unit space, thereby forming a channel in the activated three-dimensional carbon network structure. Specifically, the adjacent unit spaces are three-dimensionally brought into contact with each other, and the unit spaces may be arranged in a regular pattern.

According to an exemplary embodiment of the present invention, the activated three-dimensional carbon network structure may constantly control the distance between the nodes, and the size of the unit space may be constantly controlled through the control of the distance.

According to an exemplary embodiment of the present invention, the distance between a center of one node and a center of a node adjacent to the one node may be 100 nm or more and 3 μm or less. Specifically, the distance between a center of one node and a center of a node adjacent to the one node may be 100 nm or more and 1 μm or less, 200 nm or more and 800 nm or less, 400 nm or more and 800 nm or less, 500 nm or more and 750 nm or less, 600 nm or more and 750 nm or less, or 650 nm or more and 750 nm or less.

According to an exemplary embodiment of the present invention, a fiber connecting one node to a node adjacent to the one node may have a diameter of 50 nm or more and 1.5 μm or less. Specifically, the fiber may have a diameter of 50 nm or more and 500 nm or less, 100 nm or more and 400 nm or less, 200 nm or more and 400 nm or less, 200 nm or more and 350 nm or less, 200 nm or more and 300 nm or less, or 200 nm or more and 250 nm or less.

According to an exemplary embodiment of the present invention, the diameter of the fiber may mean a diameter at a middle point between two nodes.

According to an exemplary embodiment of the present invention, a volume of one unit space may be 90% or more and 110% or less of a volume of the other unit space.

According to an exemplary embodiment of the present invention, the node inside the activated three-dimensional carbon network structure has 4 branches, and the unit space inside the activated three-dimensional carbon network structure may be divided by 8 nodes and a fiber connecting the nodes.

According to an exemplary embodiment of the present invention, the node on the outermost surface of the activated three-dimensional carbon network structure may have the number of branches, which is one less than that of the nodes positioned inside thereof.

According to an exemplary embodiment of the present invention, the node inside the activated three-dimensional carbon network structure has 4 branches, the unit space inside the activated three-dimensional carbon network structure is divided by 8 nodes and a fiber connecting the nodes, and the shape of the unit space may be a spherical shape.

The spherical shape does not necessarily mean a perfect spherical shape, and the present invention may include a case where the unit space is formed similarly to a spherical shape as a polyhedron.

FIG. 2 is a scanning electron microscope image illustrating one surface of an activated three-dimensional carbon network structure according to an exemplary embodiment of the present invention. According to FIG. 2, it can be seen that the node inside thereof has 4 branches, the unit space is divided by 8 nodes and a fiber connecting the nodes, and a shape of the unit space is a spherical shape. FIG. 2 only shows that the cross section of the activated three-dimensional carbon network structure is not constantly cut when being cut in order to obtain an enlarged image, and as a result, the difference between the diameters of the unit spaces on the surface thereof is large, but the unit space inside thereof is formed with a uniform size.

According to an exemplary embodiment of the present invention, the node inside the activated three-dimensional carbon network structure has 5 branches, and the unit space inside the activated three-dimensional carbon network structure may be divided by 12 nodes and a fiber connecting the nodes.

According to an exemplary embodiment of the present invention, the node on the outermost surface of the activated three-dimensional carbon network structure may have the number of branches, which is one less than that of the nodes positioned inside thereof.

According to an exemplary embodiment of the present invention, the node inside the activated three-dimensional carbon network structure has 5 branches, the unit space inside the activated three-dimensional carbon network structure is divided by 12 nodes and a fiber connecting the nodes, and the shape of the unit space may be a hexahedron.

The hexahedron does not necessarily mean a perfect hexahedral shape, and the present invention may include a case where the unit space is formed similarly to a hexahedron.

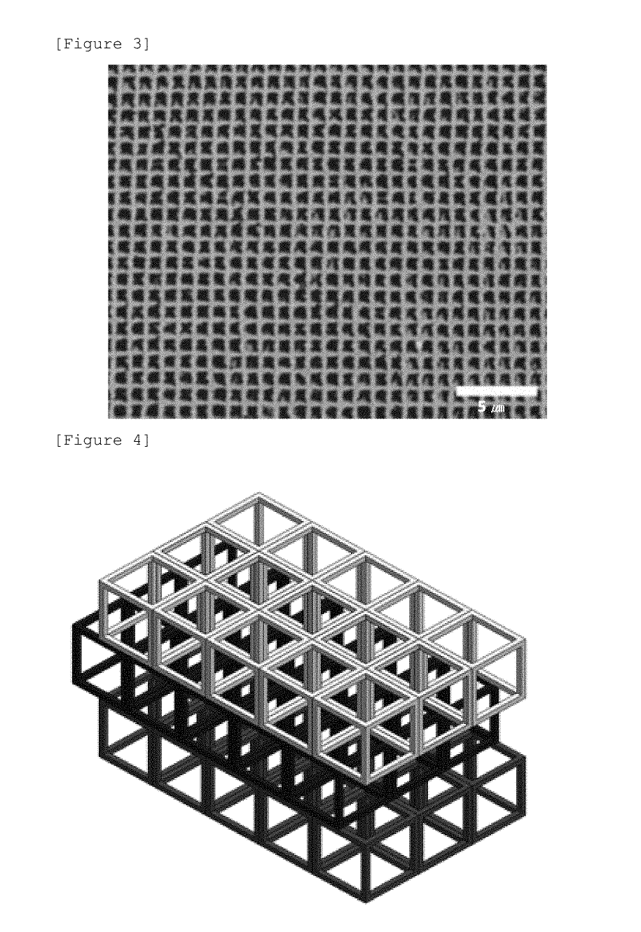

FIG. 3 is a scanning electron microscope image illustrating one surface of an activated three-dimensional carbon network structure according to an exemplary embodiment of the present invention. Further, FIG. 4 schematically illustrates the structure of the three-dimensional carbon network structure of FIG. 3. According to FIGS. 3 and 4, it can be confirmed that the node inside thereof has 5 branches, the unit space inside thereof is divided by 12 nodes and a fiber connecting the nodes, and a shape of the unit space is hexahedron.

According to an exemplary embodiment of the present invention, a central axe of one unit space and central axes of at least one unit space brought into contact with the one unit space are provided in an alternate manner. Specifically, the central axes of one unit space and at least one unit space brought into contact with the one unit space may not coincide with each other.

Referring to FIG. 2, it can be confirmed that the central axes of one unit space and at least one unit space brought into contact with the one unit space do not coincide with each other, and are folded while being alternate with each other. Specifically, at least one central axis of one unit space and the other unit space brought into contact with the one unit space may be positioned on a side surface of the one unit space. In addition, the unit spaces of the activated three-dimensional carbon network structure may be arranged in a structure such as a woodpile.

According to an exemplary embodiment of the present invention, the node and the fiber, which constitute the framework of the activated three-dimensional carbon network structure, may include a carbon material. Specifically, the node and the fiber, which constitute the framework of the activated three-dimensional carbon network structure, may be composed of a carbon material.

According to an exemplary embodiment of the present invention, the carbon material may be a carbide of a photoresist polymer. As the photoresist polymer, it is possible to apply a polymer material generally used in the art.

According to an exemplary embodiment of the present invention, nanopores are distributed in the framework constituting the activated three-dimensional carbon network structure, and the nanopores may be produced by treating a carbide with a strong base as mentioned below, and then sintering the treated carbide. During a process in which the nanopores are formed, carbon activated with oxygen may be present in plural numbers on the surface of the node and the fiber.

Specifically, according to an exemplary embodiment of the present invention, the node and the fiber include activated carbon, and the activated carbon may be included in a form of at least one of —C—O—C—, —C—OH, —C═O, and —COOH in the node and the fiber.

Another exemplary embodiment of the present invention provides a method for fabricating the activated three-dimensional carbon network structure.

Specifically, another exemplary embodiment of the present invention provides a method for fabricating an activated three-dimensional carbon network structure, the method including: preparing a photoresist layer; irradiating a three-dimensional light interference pattern onto the photoresist layer by using a plurality of coherent parallel lights; forming a three-dimensional polymer network structure by developing the photoresist layer onto which the three-dimensional light interference pattern is irradiated; forming a three-dimensional carbon network structure by sintering the three-dimensional polymer network structure; and forming an activated three-dimensional carbon network structure by treating the three-dimensional carbon network structure with a strong base, and then sintering the treated three-dimensional carbon network structure,

in which the activated three-dimensional carbon network structure is composed of a plurality of nodes and fibers connecting adjacent nodes, a plurality of unit spaces divided by the nodes and the fiber is repeatedly arranged in three-dimensional contact with each other, and the nodes and the fibers include nanopores.

The configuration of the activated three-dimensional carbon network structure, the node, the fiber, the unit space, and the like in the method for fabricating the activated three-dimensional carbon network structure may be the same as that described above.

In the fabrication method according to an exemplary embodiment of the present invention, the three-dimensional carbon network structure may mean a structure in which the three-dimensional polymer network structure is carbonized as a structure before nanopores are formed.

The fabrication method according to an exemplary embodiment of the present invention has an advantage in that it is possible to overcome a problem such as a decrease in ion active surface due to a high interlayer contact resistance and an irregular interlayer interval in a laminated electrode in the related art because a pore pattern of an activated three-dimensional carbon network structure, that is, a unit space can be formed by a one-time process by irradiating a three-dimensional light interference pattern.

According to an exemplary embodiment of the present invention, the forming of the three-dimensional carbon network structure may include sintering the three-dimensional polymer network structure at a temperature of 500° C. to 1,500° C. Specifically, the sintering temperature in the forming of the three-dimensional carbon network structure may be 600° C. to 1,200° C., or 700° C. to 1,200° C.

When the sintering temperature is less than 500° C., the three-dimensional polymer network structure may not be smoothly formed as a three-dimensional carbon network structure, and when the sintering temperature is more than 1,500° C., the process costs are extremely increased as compared to the improvement in performance of the three-dimensional carbon network structure, so that the benefits during the fabrication may be reduced.

According to an exemplary embodiment of the present invention, the treatment with a strong base in the forming of the activated three-dimensional carbon network structure may be coating the surface of the node and the fiber of the three-dimensional carbon network structure with a basic solution including at least one of KOH, NaOH, Ca(OH)₂, Mg(OH)₂, and Ba(OH)₂.

According to an exemplary embodiment of the present invention, the basic solution may be a basic solution at 1 M or more and 15 M or less, or 2 M or more and 10 M or less. Specifically, the basic solution may be a basic solution at 3 M or more and 9 M or less. When the concentration of the basic solution is more than the above range, the number of micropores is extremely increased, and as a result, the rigidity of the activated three-dimensional carbon network structure is significantly reduced, so that there is a problem in that a three-dimensional structure may be collapsed. However, the concentration is not limited thereto, and the concentration of the basic solution may be adjusted, if necessary.

The treatment with the strong base may use a publicly-known method such as an impregnation process, a coating process such as spin coating, and a spray spraying process.

According to an exemplary embodiment of the present invention, the forming of the activated three-dimensional carbon network structure may include sintering the three-dimensional carbon network structure treated with the strong base at a temperature of 300° C. to 1,200° C. Specifically, the sintering temperature in the forming of the activated three-dimensional carbon network structure may be 300° C. to 1,000° C., or 300° C. to 800° C., or 500° C. to 700° C.

According to an exemplary embodiment of the present invention, the strong base may be a KOH solution. When the activated three-dimensional carbon network structure is formed by using the KOH, the reactions of the following (1) to (4) simultaneously or continuously occur as chemical reactions in the three-dimensional carbon network structure.

2KOH→K₂O+H₂O (1)

C+H₂O→CO+H₂ (2)

CO+H₂O→CO₂+H₂ (3)

CO₂+K₂O→K₂CO₃ (4)

Specifically, during the sintering at a temperature of 300° C. to 800° C., KOH is dehydrated, so that the reaction of (1) occurs, and carbon constituting the node and the fiber allows the reaction of (2) to proceed, and as a result, carbon may be consumed. In addition, K₂CO₃ may be formed through the reactions of (3) and (4). Furthermore, the reaction between carbon constituting the node and the fiber and KOH may proceed as in the reaction of the following (5).

6KOH+2C→2K+3H₂+2K₂CO₃ (5)

K₂CO₃ formed in the reaction of (4) and/or (5) may be decomposed into CO₂ and K₂O at high temperature as in the reaction of the following (6), and as in the reaction of the following (7), CO₂ may react with carbon constituting the node and the fiber to form CO. Furthermore, as in the reactions of the following (8) and (9), the produced potassium compounds (K₂CO₃ and K₂O) may be reduced by carbon constituting the node and the fiber to form potassium metal.

K₂CO₃→K₂O+CO₂ (6)

CO₂+C→2CO (7)

K₂CO₃+2C→2K+3CO (8)

C+K₂O→2K+CO (9)

The aforementioned reaction is only one example, and nanopores of the node and the fiber of the three-dimensional carbon network structure may be formed through treatment with a basic solution and the sintering. Through this, nanopores are formed inside and outside of the node and the fiber, so that a high performance may be implemented by further increasing the specific surface area of the activated three-dimensional carbon network structure.

Further, through the forming of the activated three-dimensional carbon network structure, the node and the fiber may include activated carbon, and the activated carbon may be included in a form of at least one of —C—O—C—, —C—OH, —C═O, and —COOH in the node and the fiber.

According to an exemplary embodiment of the present invention, the three-dimensional light interference pattern may be formed by overlappingly irradiating 3 or more and 5 or less coherent parallel lights.

When the three-dimensional light interference pattern is formed by overlappingly irradiating 6 or more coherent parallel lights, the benefit of improving the performance of the three-dimensional carbon network structure is insignificant, the fabrication process is complicated, and the facility costs are increased, so that the benefit during the fabrication may be reduced.

According to an exemplary embodiment of the present invention, the irradiating of the three-dimensional light interference pattern may irradiating a three-dimensional light interference pattern formed by using 4 or 5 coherent parallel lights onto a photoresist layer. In this case, the coherent parallel light may be produced by applying a method of dividing one coherent parallel light into a plurality of lights or irradiating one coherent parallel light onto a polyhedral prism, but the production method is not limited thereto. Specifically, the irradiating of the three-dimensional light interference pattern may be irradiating a three-dimensional light interference pattern onto a photoresist layer by fixing a polyhedral prism on a substrate including the photoresist layer, and then forming the three-dimensional light interference pattern using a plurality of parallel lights formed by laser-irradiating a UV light source of about 300 nm to about 400 nm or a visible light of about 400 nm to about 450 nm.

According to an exemplary embodiment of the present invention, the irradiating of the three-dimensional light interference pattern may be forming a three-dimensional porous polymer pattern on a photoresist layer by irradiating the three-dimensional light interference pattern onto the photoresist layer using a three-dimensional light interference lithography. The light interference pattern is a pattern in which constructive interference and destructive interference are periodically repeated, and when the three-dimensional light interference pattern is irradiated onto the photoresist layer, a photoreaction relatively proceeds only in a constructive interference region, and the photoreaction may not proceed in a destructive interference region.

According to an exemplary embodiment of the present invention, a lattice constant of the three-dimensional porous polymer pattern may be adjusted depending on the incident angle of the irradiated coherent parallel light.

According to an exemplary embodiment of the present invention, the size of the unit space of the activated three-dimensional carbon network structure may be adjusted depending on the intensity or irradiation time of the irradiated coherent parallel light. In addition, since the pattern formed on the photoresist layer may have a shape in which the unit space of a spherical or hexahedral shape is repeated, and can be formed as various lattice structures by adjusting the angle and direction of light to be irradiated, the pattern is not limited to the shape. Furthermore, the size of the unit space may also be adjusted by adjusting the irradiation (exposure) time, the crosslinking (post-exposure baking) time, and the like of interference light to be irradiated.

According to an exemplary embodiment of the present invention, the preparing of the photoresist layer may be forming a photoresist layer by using a photoresist polymer on a substrate. Specifically, the preparing of the photoresist layer may include applying a photoresist polymer through various coating methods.

As the photoresist polymer, it is possible to use various polymers whose solubilities are selectively changed because the polymer is crosslinked or the chemical structure thereof is changed by a photoreaction. Specifically, as the photoresist polymer, it is possible to use all of a negative type photoresist polymer, a positive type photoresist polymer, or those other than the negative type and positive type photoresist polymers, but the photoresist polymer is not limited thereto. For example, it is possible to use SU-8 which is an epoxy-substrate negative photoresist of the negative type, and a photoresist solution may be produced by dissolving an SU-8 photoresist and a photoinitiator (PI, for example, IRGACURE 261, and the like) in γ-butyrolactone (GBL), but the photoresist polymer and the method for producing the photoresist solution is not limited thereto. For example, a bonding layer may be additionally formed between the substrate and the photoresist layer, but the formation aspect is not limited thereto.

According to an exemplary embodiment of the present invention, the forming of the activated three-dimensional polymer network structure may include developing a photoresist layer onto which the three-dimensional light interference pattern is irradiated by heat-treating and washing the photoresist layer.

According to an exemplary embodiment of the present invention, the heat treatment may be carried out at a temperature of 50° C. to 100° C. Through the heat treatment, the photoresist layer may be stabilized.

According to an exemplary embodiment of the present invention, the washing may include removing a predetermined site of the photoresist layer by using a developing solution. The predetermined site of the photoresist layer may be a photoresist region which is exposed or a photoresist region which is not exposed according to a photoresist to be used.

Still another exemplary embodiment of the present invention provides an electrode including the activated three-dimensional carbon network structure.

According to an exemplary embodiment of the present invention, the electrode may be an electrode for a secondary battery, an electrode for a fuel cell, or an electrode for a supercapacitor.

According to an exemplary embodiment of the present invention, the electrode may be an electrode for a lithium ion secondary battery. The electrode for a lithium ion secondary battery may be a negative electrode. According to an exemplary embodiment of the present invention, the activated three-dimensional carbon network structure may be applied as a material which replaces a negative electrode active material of a lithium ion secondary battery in the related art. Since the activated three-dimensional carbon network structure has a high specific surface area and a uniform durability structure, it is possible to implement a performance which is much higher than that of an existing electrode material for a secondary battery. Furthermore, nanopores are included in a node and a fiber which constitute the activated three-dimensional carbon network structure, so that there is also a benefit in that better electrical conductivity may be implemented by implementing a much higher specific surface area.

According to an exemplary embodiment of the present invention, the electrode for a lithium ion secondary battery may include the activated three-dimensional carbon network structure and a binder. Specifically, the electrode for a lithium ion secondary battery may be formed by applying an electrode composition including the activated three-dimensional carbon network structure, a binder, and a solvent onto a current collector, and then drying the electrode composition. The binder and the solvent may be applied without limitation as long as the binder and the solvent are generally used in the art.

An exemplary embodiment of the present invention provides a lithium ion secondary battery including an electrode including the activated three-dimensional carbon network structure. Specifically, the lithium ion secondary battery may include an electrode including the activated three-dimensional carbon network structure, a separator, an electrolyte, and a counter electrode. The counter electrode may be a positive electrode, and the separator, the electrolyte, and the counter electrode may be applied without limitation as long as the separator, the electrolyte, and the counter electrode are generally used in the art.

According to an exemplary embodiment of the present invention, the electrode may be an electrode for a fuel cell. Specifically, the electrode may be an electrode layer provided on one surface of an electrode membrane of a fuel cell. More specifically, the electrode for a fuel cell may be an electrode in which an electrode catalyst is provided by employing the activated three-dimensional carbon network structure as a support. Further, the electrode may be provided by replacing one electrode of a membrane electrode assembly of a fuel cell.

An exemplary embodiment of the present invention provides a fuel cell including an electrode including the activated three-dimensional carbon network structure. Specifically, the fuel cell includes an electrode including the activated three-dimensional carbon network structure in at least one electrode, and the other configuration may be applied without limitation as long as the other configuration is generally used in the art.

According to an exemplary embodiment of the present invention, the electrode may be an electrode for a supercapacitor. Specifically, the electrode may be an electrode for a micro supercapacitor. Since the activated three-dimensional carbon network structure has a much higher specific surface area and a much more uniform durability structure than those of an activated carbon electrode used as an electrode for a supercapacitor in the related art, the performance of the supercapacitor may be significantly improved. Furthermore, nanopores are included in a node and a fiber which constitute the activated three-dimensional carbon network structure, so that there is also a benefit in that better electrical conductivity may be implemented by implementing a much higher specific surface area.

An exemplary embodiment of the present invention provides a supercapacitor including an electrode including the activated three-dimensional carbon network structure. Specifically, the supercapacitor may include a supercapacitor in which an electrolyte is provided between an anode including the activated three-dimensional carbon network structure and a cathode including the activated three-dimensional carbon network structure. As the other configuration except for the electrode of the supercapacitor, a configuration of a supercapacitor in the related art may be applied without limitation.

According to an exemplary embodiment of the present invention, the supercapacitor may be a supercapacitor in which electrodes including the activated three-dimensional carbon network structure patterned in a comb shape are provided alternately with each other. Specifically, the supercapacitor may include a structure in which electrodes are engaged with each other by an interdigit structure, and a much higher capacitor capacitance may be implemented through this.

Hereinafter, the present invention will be described in detail with reference to Examples for specifically describing the present invention. However, the Examples according to the present invention may be modified in various different forms, and it is not interpreted that the scope of the present invention is limited to the Examples to be described below. The Examples of the present specification are provided for more completely explaining the present invention to the person with ordinary skill in the art.

### [Example] Fabrication of Activated Three-Dimensional Carbon Network Structure

A photoresist solution was produced by dissolving 60 wt % of a negative type SU-8 photoresist and 5 wt % of a photoinitiator (IRGACURE 261) in γ-butyrolactone (GBL). A photoresist layer having a thickness of 12 to 14 μm was formed by applying the produced photoresist solution onto a quartz substrate at 1,500 rpm by a spin-coating method, and then heat-treating the applied quartz substrate at 65° C. and 95° C. for 10 minutes and 10 minutes, respectively.

After a polyhedral prism was fixed at the upper portion of the substrate on which the photoresist layer was formed, a three-dimensional light interference pattern formed by allowing a laser beam (a wavelength of 532 nm, Nd:YVO₄) to pass through the polyhedral prism was irradiated onto the photoresist layer.

And, the photoresist layer onto which the three-dimensional light interference pattern was irradiated was heat-treated at 65° C. for 3 minutes and 95° C. for 1 minute, and the photoresist layer was developed by a method for washing the photoresist layer with a propylene glycol monomethyl ether acetate (PGMEA) solution, thereby obtaining a three-dimensional polymer network structure.

Furthermore, a three-dimensional carbon network structure was fabricated by sintering the three-dimensional polymer network structure at a heating rate of 5° C./min at a temperature of 900° C. in the inert atmosphere.

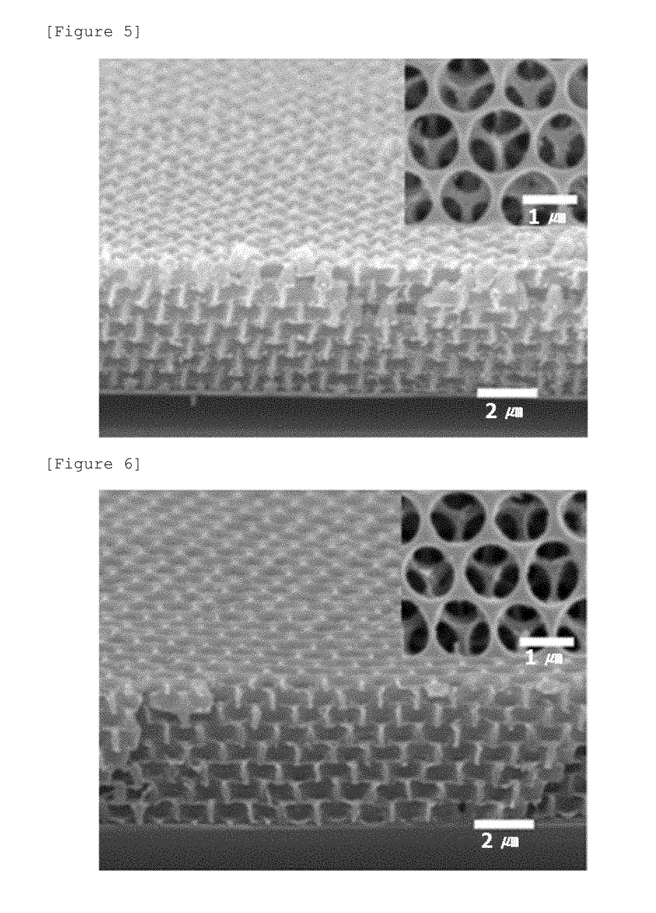

FIG. 5 illustrates a scanning electron microscope image of a three-dimensional carbon network structure fabricated according to Example 1.

Furthermore, the three-dimensional carbon network structure was coated with a 3 M KOH solution (Example 1), a 5 M KOH solution (Example 2), a 7 M KOH solution (Example 3), or a 9 M KOH solution (Example 4) by spin-coating the KOH solution onto the three-dimensional carbon network structure, and the coated three-dimensional carbon network structure was dried in an oven at 90° C. in order to remove water. Furthermore, an activated three-dimensional carbon network structure was fabricated by sintering the three-dimensional carbon network structure treated with the KOH solution at a heating rate of 5° C./min at a temperature of 600° C. for 30 minutes in the inert atmosphere. The residue of KOH was removed by washing the activated three-dimensional carbon network structure fabricated as described above with hydrochloric acid and distilled water.

FIG. 6 illustrates an electron microscope image of an activated three-dimensional carbon network structure fabricated according to Example 1 (KOH 3 M).

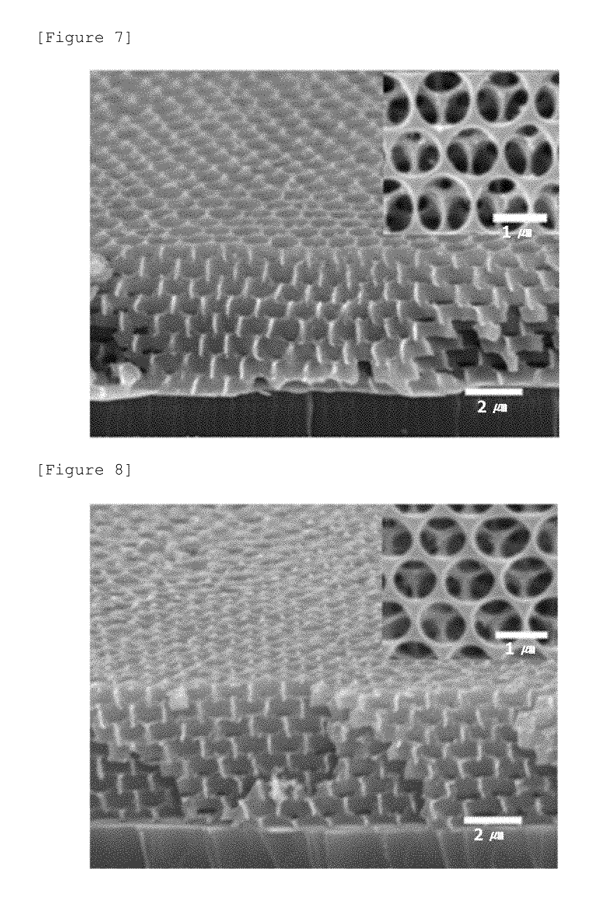

FIG. 7 illustrates an electron microscope image of an activated three-dimensional carbon network structure fabricated according to Example 2 (KOH 5 M).

FIG. 8 illustrates an electron microscope image of an activated three-dimensional carbon network structure fabricated according to Example 3 (KOH 7 M).

FIG. 9 illustrates an electron microscope image of an activated three-dimensional carbon network structure fabricated according to Example 4 (KOH 9 M). Further, FIG. 1 illustrates a scanning electron microscope image of an activated three-dimensional carbon network structure fabricated according to Example 4.

According to FIGS. 6 to 9, it can be confirmed that the activated three-dimensional carbon network structures according to Examples 1 to 4 have a uniform structure because uniform unit spaces having a diameter of about 1 μm are regularly arranged. In addition, according to FIGS. 6 to 9, it can be confirmed that the concentration of the KOH solution rarely affects the size of the unit space of the activated three-dimensional carbon network structure.

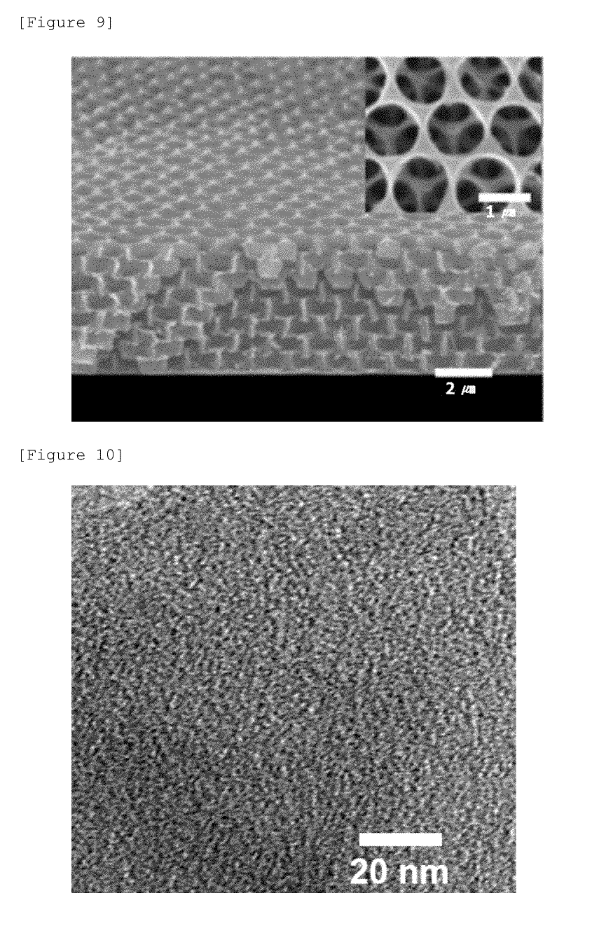

FIG. 10 illustrates a transmission electron microscope image of a fiber region of an activated three-dimensional carbon network structure fabricated according to Example 1 (KOH 3 M). According to FIG. 10, it can be seen that a fiber region of the activated three-dimensional carbon network structure according to the present invention exhibits a high specific surface area because nanopores having a diameter of about 1 nm to about 2 nm are distributed.

### [Comparative Example]—Fabrication of Three-Dimensional Carbon Network Structure in which Micropores are not Formed

A photoresist solution was produced by dissolving 60 wt % of a negative type SU-8 photoresist and 5 wt % of a photoinitiator (IRGACURE 261) in γ-butyrolactone (GBL). A photoresist layer having a thickness of 12 to 14 μm was formed by applying the produced photoresist solution onto a quartz substrate at 1,500 rpm by a spin-coating method, and then heat-treating the applied quartz substrate at 65° C. and 95° C. for 10 minutes and 10 minutes, respectively.

After a polyhedral prism was fixed at the upper portion of the substrate on which the photoresist layer was formed, a three-dimensional light interference pattern formed by allowing a laser beam (a wavelength of 532 nm, Nd:YVO₄) to pass through the polyhedral prism was irradiated onto the photoresist layer.

And, the photoresist layer onto which the three-dimensional light interference pattern was irradiated was heat-treated at 65° C. and 95° C. for 3 minutes and 1 minute, respectively, and the photoresist layer was developed by a method for washing the photoresist layer with a propylene glycol monomethyl ether acetate (PGMEA) solution, thereby obtaining a three-dimensional polymer network structure.

Furthermore, a three-dimensional carbon network structure in which micropores were not formed was fabricated by sintering the three-dimensional polymer network structure at a heating rate of 5° C./min at a temperature of 900° C. in the inert atmosphere.

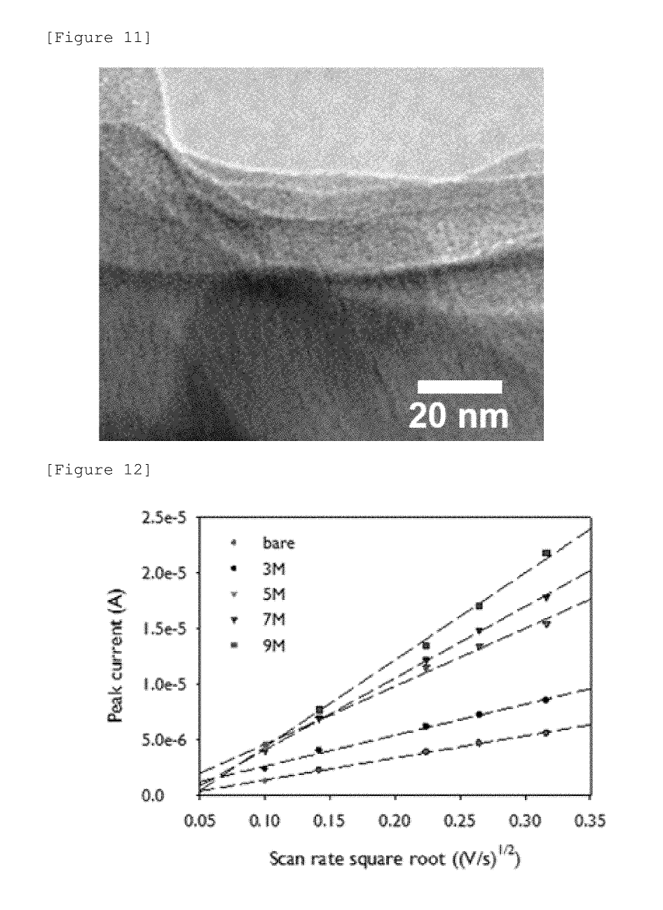

FIG. 11 illustrates a transmission electron microscope image of a fiber region of a three-dimensional carbon network structure fabricated according to the Comparative Example. According to FIG. 11, it can be confirmed that unlike the Examples, micropores are not formed in a fiber region of the three-dimensional carbon network structure.

### [Experimental Example 1]—Measurement of Active Region

In order to confirm that the surface area was increased due to the formation of the micropores according to Examples 1 to 4, the electrochemical capacitance was measured. Furthermore, in order to compare the performances in Examples 1 to 4, the electrochemical capacitance of the three-dimensional carbon network structure according to the Comparative Example was also measured.

Specifically, the electrochemical capacitance was measured by using a cyclic voltammetry in a three-electrode cell, and in the three-electrode cell, the electrochemical capacitance was measured by using the structures in Examples 1 to 4 and the structure according to the Comparative Example, Ag/AgCl, and Pt were used as a working electrode, a reference electrode, and a counter electrode, respectively, using a 1 M KCl solution including 5 mM of K₃Fe(CN)₆ as an electrolyte solution, and using VersaSTAT 3 (AMETEK) within a potential range from 0 V to 1 V and at a scan rate of 100 mV/s.

Since the micropore regions in Examples 1 to 4 are regions where the oxidation and reduction reactions of electrolyte ions occur, the active regions may be calculated by using the Randles-Sevcik Equation.

Iₚ=268,600 n^{3/2} A D^{1/2} C v^{1/2}

In the Randles-Sevcik Equation, Iₚ means a peak current (A), A means an electrically active region (cm²), C means the concentration (mol/cm³) of an electrically active species, n means the number of electrons exchanged, D means the diffusion coefficient (cm²/s), and v means the scan speed (V/s).

In the Randles-Sevcik Equation, an active region can be calculated through a slope for Iₚ and v in an electron transfer control process, and specifically, an effectively active region can be calculated through a slope for Iₚ and v^{1/2}.

FIG. 12 illustrates effectively active regions of Examples 1 to 4 and the Comparative Example. Specifically, FIG. 12 illustrates the effectively active regions of Example 1 (3 M), Example 2 (5 M), Example 3 (7 M), Example (9 M), and the Comparative Example (bare). According to FIG. 12, it can be confirmed that Examples 1 to 4 in which micropores are formed exhibit higher active regions than the Comparative Example in which micropores are not formed. In particular, it can be confirmed that Example 4 exhibits an active region which is 13.3 times higher than that of the Comparative Example.

### [Experimental Example 2]—Measurement of Electrochemical Capacitance

In order to measure the electrochemical capacitances of the structures according to Examples 1 to 4 and the Comparative Example, the electrochemical capacitances were measured by using a cyclic voltammetry and a galvonostatic charge/discharge method in a three-electrode cell. Specifically, in the three-electrode cell, the electrochemical capacitance and the galvanostatic charge/discharge were measured by using a three-dimensional carbon network structure, Ag/AgCl, and Pt as a working electrode, a reference electrode, and a counter electrode, respectively, using a solution of 1.0 M H₂SO₄ (Sigma-Aldrich) as an electrolyte solution, and using VersaSTAT 3 (AMETEK) within a potential range from 0 V to 1 V and at a scan rate of 100 mV/s.

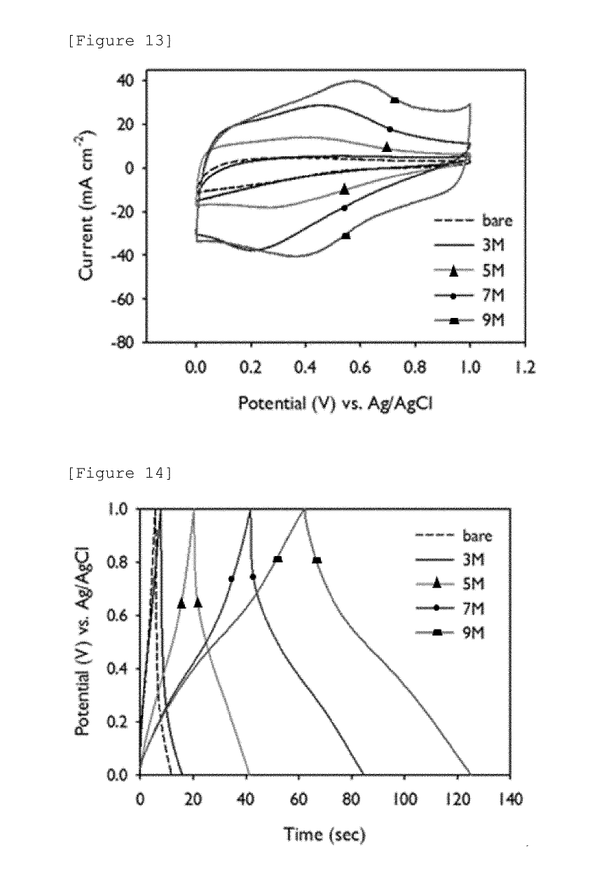

FIG. 13 illustrates electrochemical capacitances (cyclic voltammetry curves) of Examples 1 to 4 and the Comparative Example. Specifically, according to FIG. 11, it can be seen that Example 1 (3 M), Example 2 (5 M), Example 3 (7 M), and Example 4 (9 M) exhibit a high current density as compared to the Comparative Example (bare). Furthermore, when a treatment is performed by increasing the concentration of the KOH solution, it can be seen that as the number of micropores is increased, a much higher current density is exhibited.

FIG. 14 illustrates galvanostatic charge/discharge curves at a current density of 1 mA/cm² of Examples 1 to 4 and the Comparative Example. According to FIG. 14, it can be seen that Example 1 (3 M), Example 2 (5 M), Example 3 (7 M), and Example 4 (9 M) implement high specific capacitance as compared to the Comparative Example (bare). Furthermore, similarly to the result of the electrochemical capacitance, it can be seen that as the number of micropores is increased, the specific capacitance is implemented. Specifically, in the case of Example 4, the specific capacitance was calculated as 63 mF/cm², a value which is about 10 times higher than that of the Comparative Example.

### [Experimental Example 3] Fabrication of Micro Supercapacitor

Gold (Au) was deposited to a thickness of about 10 nm onto the activated three-dimensional carbon network structure fabricated according to Example 4 by using a mask having an interdigit shape. Furthermore, an electrode having an interdigit shape was fabricated from the three-dimensional carbon network structure onto which the gold was deposited by using a reactive ion etching (RIE).

Furthermore, after a PVA/H₃PO4 gel electrolyte was mixed with an ionogel electrolyte obtained by mixing an ionic liquid 1-butyl-3-methylimidazolium bis(trifluoromethylsulfonyl)imide ([BMIM][NTf₂]) with a dry silica nano powder having an average particle diameter of 7 nm, a solid-state micro supercapacitor was fabricated by injecting the mixture between the interdigit electrodes, and then drying the mixture.

Samples in which the width of a portion protruding in the form of a finger in the electrode of the micro supercapacitor was varied into 1 μm, 2 μm, and 3 μm were prepared, and the performance thereof was measured.

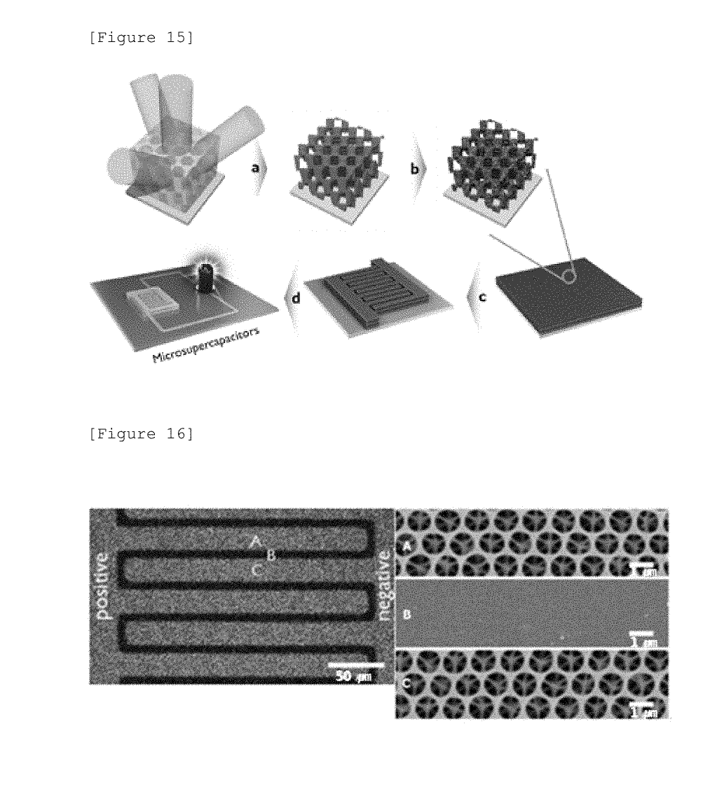

FIG. 15 schematically illustrates a process of fabricating a micro supercapacitor according to Experimental Example 3. Specifically, FIG. 15(a) illustrates that a three-dimensional polymer network structure is formed by irradiating a three-dimensional light interference pattern, FIG. 15(b) illustrates that an activated three-dimensional polymer network structure including micropores is fabricated, FIG. 15(c) illustrates that an electrode having an interdigit shape is fabricated by etching a three-dimensional carbon network structure onto which gold is deposited with an interdigit structure, and FIG. 15(d) illustrates that an electrolyte is injected between the electrodes having an interdigit shape, and the electrodes are driven.

FIG. 16 is an image in which a micro supercapacitor electrode having an interdigit structure according to Experimental Example 3 is enlarged by a scanning electron microscope. Specifically, according to FIG. 16, it can be confirmed that the regions (A) and (C), which are electrode regions, are composed of the three-dimensional carbon network structures fabricated according to the Examples, and it can be confirmed that an electrolyte region (B) is present between the regions (A) and (C).

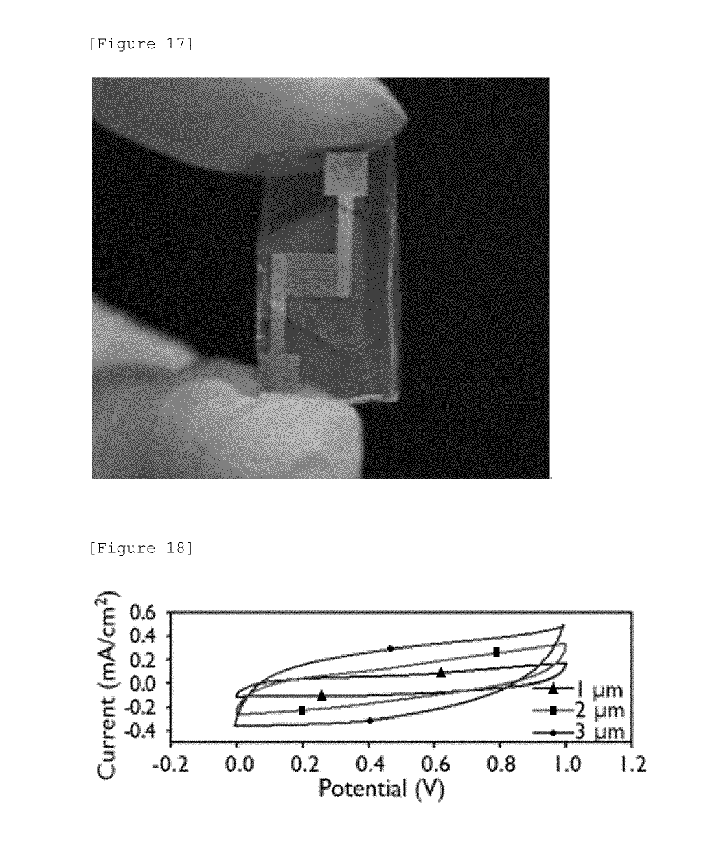

FIG. 17 illustrates an image in which the micro supercapacitor according to Experimental Example 3 is not enlarged.

FIG. 18 illustrates cyclic voltammetry curves of the micro supercapacitor electrode having an interdigit structure according to Example 3 at 100 mV/s. FIG. 19 illustrates cyclic voltammetry curves of the micro supercapacitor electrode having an interdigit structure according to Example 3 at 1,000 mV/s. According to FIGS. 17 and 18, it can be confirmed that the shapes of the C-V curves of each electrode at a scan speed of 100 mV/s and 1,000 mV/s are not significantly different from each other. Furthermore, it can be confirmed that the rectangular form is maintained even at high scan speed, which may mean exhibiting an ideal capacitance behavior.

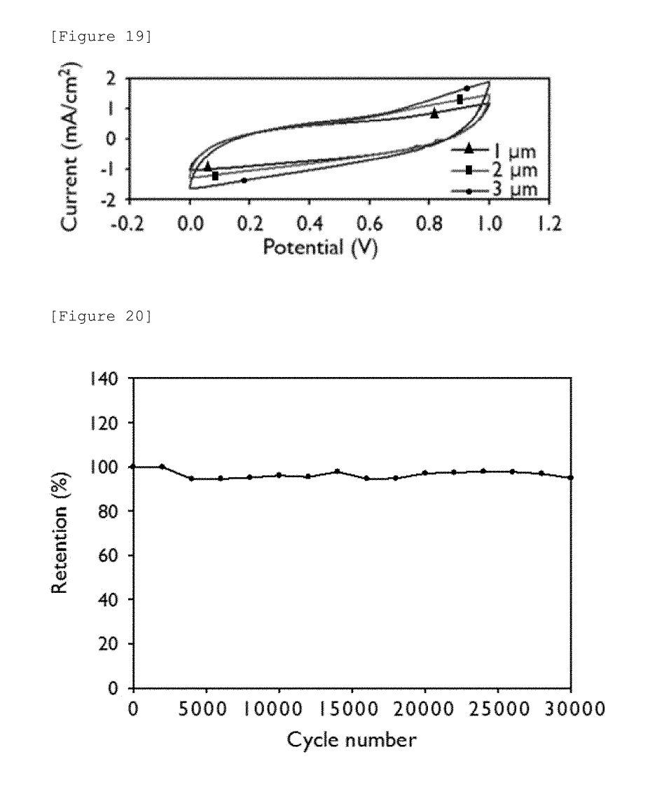

FIG. 20 illustrates storage capacitance of the micro supercapacitor electrode having an interdigit structure according to Example 3 over cycle. According to FIG. 20, it can be seen that even after a cycle of 30,000 times, storage capacitance of about 95% is exhibited, and a very stable cycle performance is implemented.

1. An activated three-dimensional carbon network structure which is composed of a plurality of nodes and a fiber connecting adjacent nodes,
wherein a plurality of unit spaces divided by the nodes and the fiber is repeatedly arranged in three-dimensional contact with each other,
a distance between a center of one node and a center of a node adjacent to the one node is 100 nm or more and 3 μm or less,
a volume of one unit space is 90% or more and 110% or less of a volume of the other unit space, and
the nodes and the fiber comprise nanopores.

2. The activated three-dimensional carbon network structure of claim 1, wherein a fiber connecting one node to a node adjacent to the one node has a diameter of 50 nm or more and 1.5 μm or less.

3. The activated three-dimensional carbon network structure of claim 1, wherein the nanopores have a diameter of 0.5 nm or more and 2 nm or less.

4. The activated three-dimensional carbon network structure of claim 1, wherein the node inside the activated three-dimensional carbon network structure has 4 branches, and the unit space inside the activated three-dimensional carbon network structure is divided by 8 nodes and a fiber connecting the nodes.

5. The activated three-dimensional carbon network structure of claim 4, wherein a shape of the unit space is a spherical shape.

6. The activated three-dimensional carbon network structure of claim 1, wherein the node inside the activated three-dimensional carbon network structure has 5 branches, and
the unit space inside the activated three-dimensional carbon network structure is divided by 12 nodes and a fiber connecting the nodes.

7. The activated three-dimensional carbon network structure of claim 6, wherein a shape of the unit space is a hexahedron.

8. The activated three-dimensional carbon network structure of claim 1, wherein a central axe of one unit space and central axes of at least one unit space brought into contact with the one unit space are provided in an alternate manner.

9. A method for fabricating an activated three-dimensional carbon network structure, the method comprising: preparing a photoresist layer;
irradiating a three-dimensional light interference pattern onto the photoresist layer by using a plurality of coherent parallel lights;
forming a three-dimensional polymer network structure by developing the photoresist layer onto which the three-dimensional light interference pattern is irradiated;
forming a three-dimensional carbon network structure by sintering the three-dimensional polymer network structure; and
forming an activated three-dimensional carbon network structure by treating the three-dimensional carbon network structure with a strong base, and then sintering the treated three-dimensional carbon network structure,
wherein the activated three-dimensional carbon network structure is composed of a plurality of nodes and fibers connecting adjacent nodes,
a plurality of unit spaces divided by the nodes and the fiber is repeatedly arranged in three-dimensional contact with each other, and
the nodes and the fibers comprise nanopores.

10. The method of claim 9, wherein the treatment with a strong base in the forming of the activated three-dimensional carbon network structure is coating the surface of the node and the fiber of the three-dimensional carbon network structure with a basic solution comprising at least one of KOH, NaOH, Ca(OH)₂, Mg(OH)₂, and Ba(OH)₂.

11. The method of claim 9, wherein the forming of the three-dimensional carbon network structure comprises sintering the three-dimensional polymer network structure at a temperature of 500° C. to 1,500° C.

12. The method of claim 9, wherein the forming of the activated three-dimensional carbon network structure comprises sintering the three-dimensional carbon network structure treated with the strong base at a temperature of 300° C. to 1,200° C.

13. The method of claim 9, wherein the three-dimensional light interference pattern is formed by overlappingly irradiating 3 or more and 5 or less coherent parallel lights.

14. The method of claim 9, wherein the forming of the three-dimensional polymer network structure comprises developing a photoresist layer onto which the three-dimensional light interference pattern is irradiated by heat-treating and washing the photoresist layer.

15. An electrode comprising the activated three-dimensional carbon network structure according to claim 1.

16. The electrode of claim 15, wherein the electrode is an electrode for a secondary battery, an electrode for a fuel cell, or an electrode for a supercapacitor.
